(19) United States
(12) Patent Application Publication
(10) Pub. No.: US 2003/0067792 A1
(43) Pub. Date: Apr. 10, 2003

(54) Voltage transformer with reduced rectifier losses and method for operating the voltage transformer

(76) Inventors: Michael Herfurth, Gilching (DE); Ilia Zverev, Munchen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/261,033

(22) Filed: Sep. 30, 2002

(30) Foreign Application Priority Data
Sep. 28, 2001 (DE) 101 47 883.6

(51) Int. Cl. H02M 3/335

(52) U.S. Cl. 363/24

(57) ABSTRACT

A voltage transformer has input terminals for the application of an alternating voltage and output terminals for the provision of a rectified output voltage. The voltage transformer has two inductive energy storage elements and two switch configurations, in each case with a first rectifier element and a first controllable switch element, wherein each of the switch configurations couples one of the energy storage elements to the input terminals and wherein the energy storage elements are coupled to the output terminals by a coupling circuit.

### BACKGROUND OF THE INVENTION

1. Field of the Invention

The present invention relates to a voltage transformer, in particular a flyback converter, with input terminals for supplying an alternating voltage and output terminals for providing an output voltage for a load.

It is common in known voltage transformers, which generate a direct voltage from an alternating voltage, that they have a diode rectifier, which is connected downstream of the input terminals and which, from the alternating voltage present at the input, generate a rectified voltage, which is then converted by a converter unit into an output voltage with a desired amplitude. In this case, the diode rectifier is usually in the form of a bridge circuit with four diodes.

A voltage transformer of this kind with a diode rectifier and a flyback converter connected downstream of the diode rectifier is described, for example, in the reference by Köstner, Möschwitzer: titled “Elektronische Schaltungen” [“Electronic Circuits”], Hanser Verlag, Munich, 1993, page 287, Fig. 2.231.

With voltage transformers of this kind, a current flows through two diodes connected in series in the diode rectifier with both the positive half wave and the negative half wave of the alternating voltage respectively. However, a power loss occurs at the diodes.

### SUMMARY OF THE INVENTION

It is accordingly an object of the invention to provide a voltage transformer with reduced rectifier losses and a method for operating the voltage transformer which overcome the above-mentioned disadvantages of the prior art devices and methods of this general type, in which the resulting power loss is reduced in comparison with known voltage transformers.

With the foregoing and other objects in view there is provided, in accordance with the invention, a voltage transformer. The voltage transformer contains input terminals for receiving an alternating voltage, output terminals outputting a rectified output voltage, a first inductive energy store element, a second inductive energy storage element, and a first switch configuration with a first rectifier element and a first controllable switch element connected to the first rectifier element. The first switch configuration is connected in series with the first energy storage element between the input terminals. A second switch configuration is provided and has a second rectifier element and a second controllable switch element connected to the second rectifier element. The second switch configuration is connected in series with the second energy storage element between the input terminals. A coupling circuit couples the first and second energy storage elements to the output terminals. A control circuit is connected to and controls the first and second controllable switch elements in dependence upon the rectified output voltage.

The voltage transformer according to the invention has the input terminals for the application of an alternating voltage, output terminals for the provision of a rectified voltage and two energy storage elements for absorbing energy from the input terminals and for releasing energy to the output terminals. Furthermore, the first switch configuration with the first rectifier element and the first controllable switch element and the second switch configuration with the second rectifier configuration and the second controllable switch element are provided. The switch element and the rectifier element of the first switch configuration are connected in series with the first inductive energy storage element between the input terminals and the switch element and the rectifier element of the second switch configuration are connected in series with the second energy storage element between the input terminals. For the control of the first and second switch element, which, in particular, are in the form of MOS transistors, a control circuit is provided, which controls the switch elements depending upon the output voltage.

With the voltage transformer according to the invention, one of the two switch configurations with the rectifier element and the switch element together with the inductive charge storage device serves to convert the positive portion or the positive half wave of the alternating voltage on the input side into the output voltage and the other of the two switch configuration with the second rectifier element and the second switch element together with the inductive charge storage element serves to convert the negative portion of the alternating voltage on the input side or the negative half wave into the output voltage.

A bridge rectifier is not necessary with the voltage transformer according to the invention. Due to the presence in each case of only one diode in each of the two branches, which in each case provide for the conversion of one half wave of the input voltage into the output voltage, the power loss that occurs is reduced in comparison with known voltage transformers, with which each branch has two diodes.

With the voltage transformer according to the invention, which constitutes a flyback converter, two inductive energy storage elements are provided, which, in each case, are in the form of primary coils of a transfer device/transformer and are inductively coupled to the output terminals by a coupling circuit. Furthermore, along with a secondary coil inductively coupled to the primary coils, the coupling circuit has a rectifier configuration connected to the output terminals.

In this embodiment, each of the two primary coils is connected in series with the switch element and the rectifier element of one of the two switch configurations between the input terminals. At the same time, the polarity of the diodes is disposed so that in each case, depending on the polarity of the input voltage, only one of the two series circuits containing, in each case, of a primary coil, a rectifier element and a switch element, which lie parallel to the input terminals, absorbs a current via the input terminals. As a result of this, in each case, only one of the two primary coils absorbs energy from the input voltage via the series-connected switch element and, when the switch is subsequently opened, releases this to the secondary coil for the supply of voltage to a load that can be connected to the output terminals. The energy stored in the primary coils is fed via the secondary coil to an output circuit to supply the load.

The inductive charge storage elements, which are in the form of primary coils, are thus inductively coupled to the output terminals.

In accordance with an added feature of the invention, the coupling circuit has a capacitive energy storage element connected between the output terminals. The coupling circuit has an inductive component inductively coupled with the first and second inductive energy storage elements and coupled to the output terminals.

In accordance with an additional feature of the invention, the first and second controllable switch elements are semiconductor switches such as MOS transistors.

In accordance with another feature of the invention, the first and second inductive energy storage elements are in each case primary coils of a transformer.

In accordance with a further feature of the invention, a capacitive filter is connected between the input terminals.

With the foregoing and other objects in view there is provided, in accordance with the invention, a method for controlling the voltage transformer as described above. The method includes cyclically controlling the first and second controllable switch elements and, in doing so, the first and second controllable switch elements are simultaneously opened and closed in each case.

Other features which are considered as characteristic for the invention are set forth in the appended claims.

Although the invention is illustrated and described herein as embodied in a voltage transformer with reduced rectifier losses, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram of a voltage transformer according to the invention in the form of a flyback converter with two inductive energy storage elements in the form of primary coils of a transformer, which are coupled to output terminals by a coupling circuit; and

FIG. 2 is a block circuit diagram of the voltage transformer according to FIG. 1 with an exemplary embodiment of a coupling circuit in detail.

### DESCRIPTION OF THE PREFERRED EMBODIMENTS

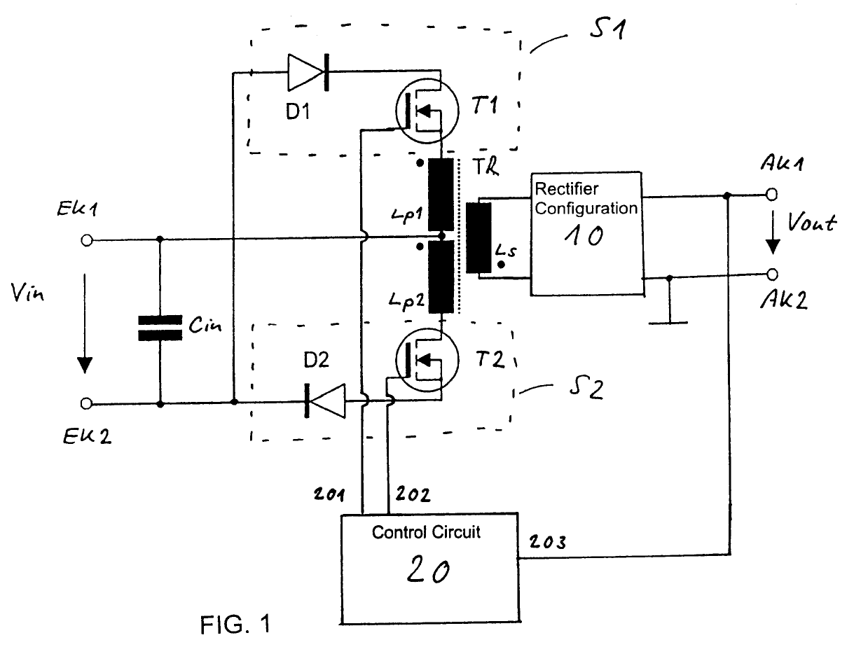

In all the figures of the drawing, sub-features and integral parts that correspond to one another bear the same reference symbol in each case. Referring now to the figures of the drawing in detail and first, particularly, to FIG. 1 thereof, there is shown an exemplary embodiment of a voltage transformer according to the invention, which is in the form of a flyback converter. The voltage transformer has input terminals EK1, EK2 at which an alternating voltage Vin is present. The alternating voltage Vin is, for example, a mains alternating voltage with a frequency of 50 Hz and a root-mean-square value between 220V and 270V. From the alternating voltage Vin, the voltage transformer generates a DC voltage Vout between output terminals AK1, AK2 of the voltage transformer, to which a non-illustrated load can be connected.

The voltage transformer shown has a first switch configuration S1 with a first switch element T1 and a rectifier element D1 in the form of a diode and a second switch configuration S2 with a second switch element T2 and a rectifier element D2 in the form of a diode as well as a first and a second inductive energy storage element Lp1, Lp2. In this case, the energy storage elements Lp1, Lp2 are in the form of primary coils of a transfer device or transformer TR. The first diode D1, the first switch element T1 and the first primary coil Lp1 are connected in series between the input terminals EK1, EK2. Parallel to these, the second primary coil Lp2, the second switch element T2 and the second diode D2 are connected in series between the input terminals EK1, EK2.

In this case, the diodes D1, D2 are connected with opposing polarity so that, depending on the polarity of the input voltage Vin, only one of the two primary coils Lp1, Lp2 can absorb current or energy via the input terminals EK1, EK2 when the respective switch element T1, T2 connected in series with it conducts. In the exemplary embodiment, the two switch elements T1, T2 are in the form of n-conducting MOS transistors, which are controlled by a control circuit 20 depending upon an output voltage Vout.

The control circuit 20 has an input 203, to which is fed the output voltage Vout or a signal dependent upon the output voltage Vout. The control circuit 20 has a first output terminal 201, which is connected to a gate connection of the first transistor T1, and a second output terminal 202, which is connected to a gate connection of the second transistor T2. As, in any case, due to the polarity of the diodes D1, D2, only one of the two primary coils Lp1, Lp2 can absorb current when the transistor T1, T2 is turned on, the two transistors T1, T2 can, in principle, be opened and closed in the same cycle, the transistors T1, T2 being driven at a floating potential by a transformer or via an optocoupler, for example. Depending on the instantaneous polarity of the input voltage Vin, one of the two primary coils Lp1, Lp2 absorbs energy when the switch T1, T2 connected in series with the primary coil is closed and releases this via a coupling circuit to the output terminals AK1, AK2 when the switch is subsequently opened. In the exemplary embodiment, the coupling circuit has a secondary coil Ls of the transformer TR, which is inductively coupled to the primary coils Lp1, Lp2, and a rectifier configuration 10 connected between the secondary coil Ls and the output terminals AK1, AK2.

In the exemplary embodiment shown in FIG. 1, the polarity of the second diode D2 is disposed in the forward direction during the positive half wave of the input voltage Vin, i.e. when the voltage between the input terminals EK1, EK2 is positive, so that the second primary coil Lp2 can absorb energy via the input terminals EK1, EK2 when the switch element T2 is turned on. During the negative half wave, when the voltage between the first input terminal EK1 and the second input terminal EK2 is negative, the polarity of the first diode D1 is disposed in the forward direction so that the first primary coil Lp1 can absorb energy via the input terminals EK1, EK2 when the switch element T1 is turned on. The series circuit with the second primary coil Lp2, the second switch element T2 and the second diode D2 thus provides for the conversion of the positive portion of the input voltage Vin into the output voltage Vout and the series circuit with the first diode D1, the first switch element T1 and the first primary coil Lp1 thus provides for the conversion of the negative portion of the input voltage Vin into the output voltage Vout.

Due to the direct conversion of the alternating voltage without intermediate connection of a bridge rectifier, with the switched-mode converter according to the invention according to FIG. 1, the number of diodes to be used is reduced to two, as a result of which the power losses occurring across the diodes is likewise reduced in comparison with known switched-mode converters.

The clock frequency, with which the switch elements T1, T2 are controlled, is significantly higher, preferably more than 100 times higher than the frequency of the input voltage Vin. The control circuit 20 compares, in a manner not described in more detail, the output voltage Vout or a signal dependent upon the output voltage Vout with a desired voltage or a reference value in order to correct the output voltage Vout depending upon the difference between the actual value of the output voltage Vout and the reference value. If the output voltage Vout becomes too high, for example as a result of a load change, the periods during which the switch elements T1, T2 are turned on are shortened in order to reduce the power consumption while, in the case of a reduction in the output voltage Vout, the periods during which the switch elements T1, T2 are turned on are extended in order to increase the power consumption. The power consumption is thus controlled by the periods for which the respective transistors T1, T2 conduct.

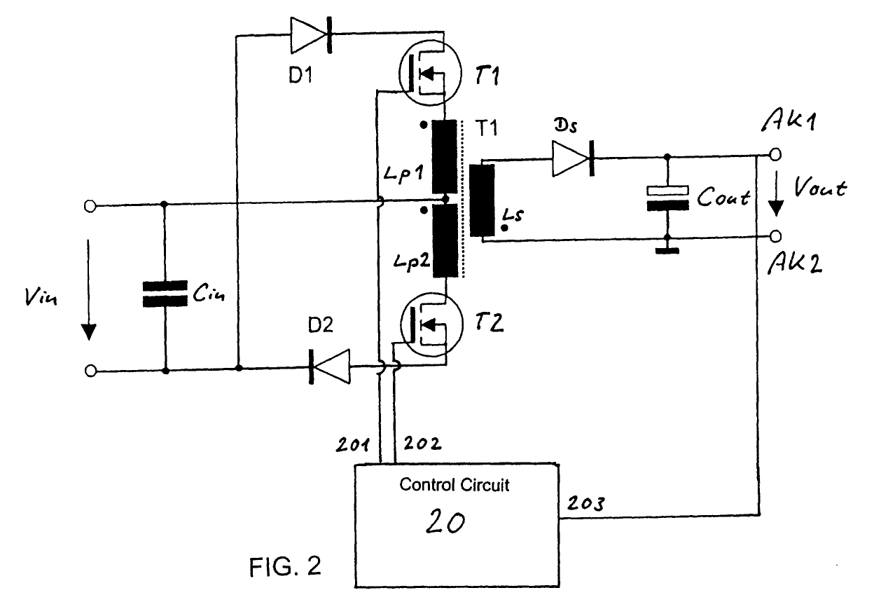

The rectifier configuration 10 shown in the block circuit diagram in FIG. 1 in the simplest case is formed of a series connection of a diode Ds and a capacitor Cout, which is connected in parallel with the primary coil Ls as is shown in FIG. 2. In this case, the output terminals AK1, AK2 are in parallel with the capacitor Cout, which is preferably in the form of an electrolytic capacitor.

A high-frequency filter, which in FIGS. 1 and 2 is in the form of a capacitor Cin, is preferably connected between the input terminals EK1, EK2, in order to filter out high-frequency interference signals, which can be superimposed on the alternating voltage.

We claim:

1. A voltage transformer, comprising:
input terminals for receiving an alternating voltage;
output terminals outputting a rectified output voltage;
a first inductive energy store element;
a second inductive energy storage element;
a first switch configuration with a first rectifier element and a first controllable switch element connected to said first rectifier element, said first switch configuration connected in series with said first energy storage element between said input terminals;
a second switch configuration with a second rectifier element and a second controllable switch element connected to said second rectifier element, said second switch configuration connected in series with said second energy storage element between said input terminals;
a coupling circuit coupling said first and second energy storage elements to said output terminals; and
a control circuit connected to and controlling said first and second controllable switch elements in dependence upon the rectified output voltage.

2. The voltage transformer according to claim 1, wherein said coupling circuit has a capacitive energy storage element connected between said output terminals.

3. The voltage transformer according to claim 1, wherein said coupling circuit has an inductive component inductively coupled with said first and second inductive energy storage elements and coupled to said output terminals.

4. The voltage transformer according to claim 1, wherein said first and second controllable switch elements are semiconductor switches.

5. The voltage transformer according to claim 1, wherein said first and second inductive energy storage elements are in each case primary coils of a transformer.

6. The voltage transformer according to claim 1, further comprising a capacitive filter connected between said input terminals.

7. The voltage transformer according to claim 1, wherein said first and second controllable switch elements are MOS transistors.

8. The voltage transformer according to claim 4, wherein said semiconductor switches are MOS transistors.

9. A method for controlling the voltage transformer according to claim 1, which comprises the step of cyclically controlling the first and second controllable switch elements and, in doing so, the first and second controllable switch elements being simultaneously opened and closed in each case.
